(19) United States
(12) Patent Application Publication
(10) Pub. No.: US 2014/0104422 A1
(43) Pub. Date: Apr. 17, 2014

(54) APPARATUS AND METHOD FOR DETERMINING PARKING AREA

(71) Applicant: HYUNDAI MOTOR COMPANY, Seoul (KR)

(72) Inventors: Jae Seob Choi, Hwaseong (KR); Dae Joong Yoon, Hwaseong (KR); Eu Gene Chang, Gunpo (KR)

(73) Assignee: Hyundai Motor Company, Seoul (KR)

(21) Appl. No.: 13/691,117

(22) Filed: Nov. 30, 2012

(30) Foreign Application Priority Data
Oct. 11, 2012 (KR) 10-2012-0113142

(51) Int. Cl. G08G 1/14; H04N 7/00

(52) U.S. Cl. CPC G08G 1/141; H04N 7/002
USPC 348/148; 340/932.2

(57) ABSTRACT

An apparatus for determining including a processor configured to: analyze a surrounding image of a vehicle; recognize a parking line in the surrounding image based the analysis of the surrounding image; sense a plurality of parking areas based on the recognized parking line; analyze the plurality of sensed parking areas divided into a plurality of predetermined intervals; determine an occupied state of the plurality of sensed parking areas based on analyzing each sensed parking area; and set an empty parking area as a parkable area.

### CROSS-REFERENCES TO RELATED APPLICATIONS

This application claims priority under 35 U.S.C. §119(a) to Korean patent application No. 10-2012-0113142 filed on Oct. 11, 2012, the disclosure of which is hereby incorporated in its entirety by reference.

### BACKGROUND OF THE INVENTION

1. Field of the Invention

The present invention relates to an apparatus and a method for determining a parking area, and more particularly, to an apparatus and a method for determining a parking area without a separate sensor.

2. Description of the Related Art

In recent years, for driver convenience, an image around a vehicle and information for neighbouring obstacles sensed by sensors disposed in a rear or a side of the vehicle may be provided to help the driver easily park the vehicle. Furthermore, technology for providing information for a parkable area among parking areas has been developed.

For example, a system which drives an operation switch when a vehicle is approaching a parkable area, drives a sensor installed at each corner of a vehicle and may detect a parking area with reference to a distance to an obstacle sensed by the sensor. However, in this related art, an additional sensor is required to measure a position and distance of an obstacle.

### SUMMARY OF THE INVENTION

The present invention provides an apparatus and a method for determining a parking area which determine a parkable area from an image around a vehicle and provide a determining result to a user, thereby allowing the user to easily park the vehicle.

The present invention further provides an apparatus and a method for determining a parking area which compares histogram variance of an image around a vehicle and determine a parkable area according to a comparison result without an additional sensor such as an ultrasonic sensor.

According to the present invention, an apparatus for determining a parking area may include a plurality of units executed by a processor within a controller having a memory. The plurality of units may include: an image analysis unit configured to analyze a surrounding image of a vehicle; a parking line recognition unit configured to recognize a parking line in the surrounding image based on an image analysis result of the image analysis unit; a parking area analysis unit configured to sense parking areas based on the recognized parking line and analyze the sensed parking areas divided into predetermined intervals; and a parking position setting unit configured to determine an occupied state of the sensed parking areas based on an analysis result for the sensed parking areas and set an empty parking area as a parkable area.

The parking area analysis unit may calculate histogram variances for analysis sections in each of the sensed parking areas and analyze change in the histogram variances for the analysis sections in each of the sensed parking areas. Additionally, the parking area analysis unit may set a histogram variance of an analysis section as a reference value when a histogram variance for each analysis section in each of the sensed parking areas is less than a threshold value.

The parking position setting unit may determine a parking area, in which change in the histogram variance for each analysis section in each of the sensed parking areas is low, as the empty parking area based on the set reference value. Additionally, the parking position setting unit may determine the empty parking area by comparing change in histogram variances of analysis sections in two adjacent parking areas, in which the analysis sections correspond to each other.

According to another aspect of the present invention, a method for determining a parking area, executed by a processor, may include analyzing a surrounding image of a vehicle; recognizing a parking line in the surrounding image based on an image analysis result for the surrounding image; sensing parking areas based on the recognized parking line and analyzing the sensed parking areas divided into predetermined fixed intervals; and determining an occupied state of the sensed parking areas according to an analysis result for the sensed parking areas and set an empty parking area as a parkable area.

The analyzing of the sensed parking areas may include calculating histogram variances for analysis sections in each of the sensed parking areas and analyzing change in the histogram variances for the analysis sections. Additionally, this analysis may include setting a histogram variance of an analysis section as a reference value when the histogram variances for the analysis sections in each of the sensed parking areas is less than a threshold value.

The setting of a parkable area may include determining a parking area, in which change in the histogram variances for the analysis sections in each of the sensed parking areas is low, as an empty parking area based on the set reference value. This process may further include determining the empty parking area by comparing change in histogram variances for analysis sections for two adjacent parking areas, in which the analysis sections correspond to each other.

Accordingly the present invention, may improve user convenience by determining a parking area and notifying a user. Furthermore, the present invention may be implemented without an additional sensor

The apparatus and methods of the present invention may include other features and advantages which will be apparent from or are set forth in more detail in the accompanying drawings, which are incorporated herein, and the following description, which together serve to explain exemplary principles of the present invention.

### BRIEF DESCRIPTION OF THE DRAWINGS

FIG. 1 is an exemplary view illustrating a vehicle including a parking area determination apparatus according to an exemplary embodiment of the present invention.

FIG. 2 is an exemplary block diagram illustrating a configuration of a parking area determination apparatus according to an exemplary embodiment of the present invention.

FIG. 3 is an exemplary view illustrating a parking area sensing operation of a parking area determination apparatus according to an exemplary embodiment of the present invention.

FIG. 4 is an exemplary view illustrating a reference value setting operation for a parking area of a parking area determination apparatus according to an exemplary embodiment of the present invention.

FIGS. 5 and 6 are exemplary views illustrating a parking area analysis operation of a parking area determination apparatus according to an exemplary embodiment of the present invention.

FIG. 7 is an exemplary view illustrating a parking area setting operation of a parking area determination apparatus according to an exemplary embodiment of the present invention.

FIGS. 8 and 9 are exemplary flowcharts illustrating a method for determining a parking area according to an exemplary embodiment of the present invention.

### DESCRIPTION OF PREFERRED EMBODIMENTS

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

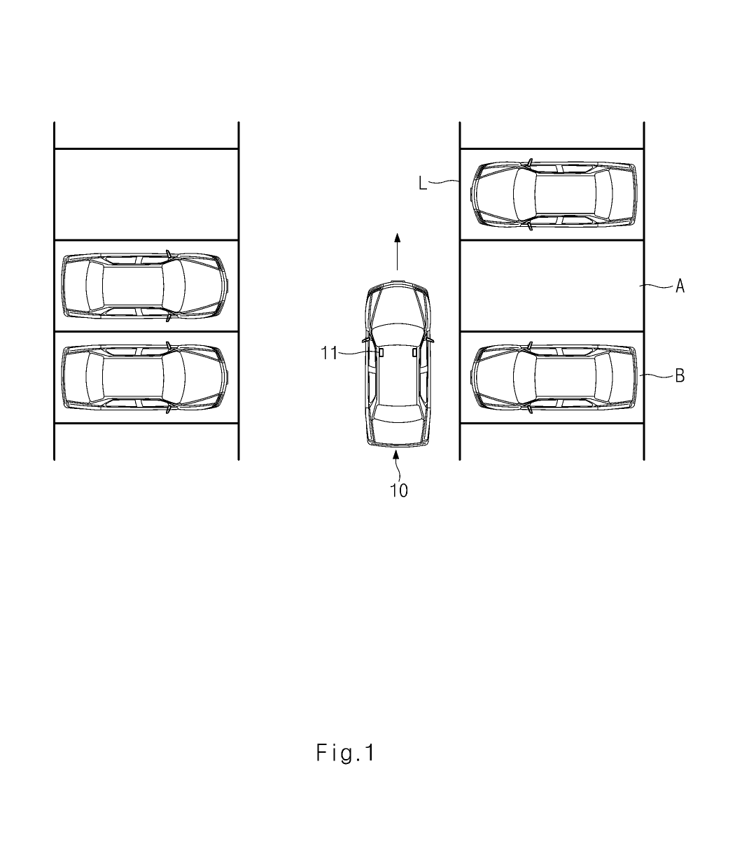

FIG. 1 is an exemplary view illustrating a vehicle including a parking area determination apparatus according to an exemplary embodiment of the present invention. Referring to FIG. 1, a vehicle 10 may include an imaging device 11 capturing a surrounding image of the vehicle. Further, the imaging device may be disposed in one direction of the vehicle. Alternatively, the imaging device may be disposed in a plurality of directions of the vehicle.

When the user travels to park the vehicle in a parking lot, the imaging device 11 disposed in the vehicle 10 may capture a surrounding image of the vehicle 10 and the parking area determination apparatus may analyze, by a processor, the surrounding image captured through the imaging device 11 to recognize a parking line L and may sense an empty parking area A among the sensed parking areas to determine a parkable area.

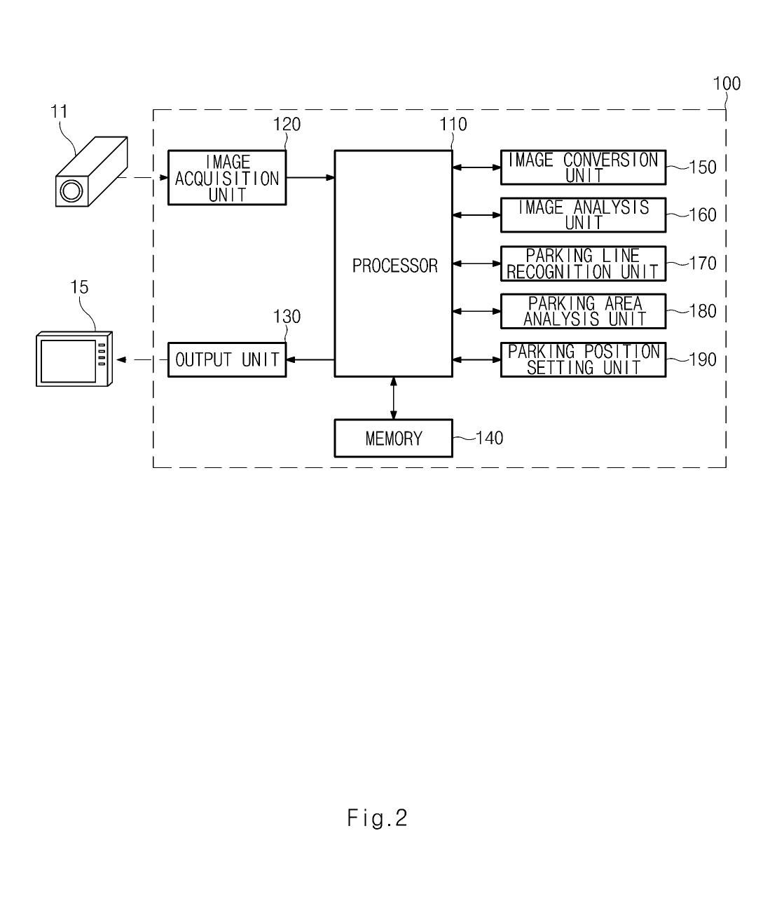

Moreover, the parking area determination apparatus may analyze, by the processor, the surrounding image in units of parking areas and sense the empty parking area A by comparing a histogram variance of the empty parking area and a histogram variance of an occupied parking area B. A detailed configuration of the parking area determination apparatus will be described with reference to FIG. 2.

FIG. 2 is an exemplary block diagram illustrating a configuration of a parking area determination apparatus according to the present invention.

Referring to FIG. 2, a parking area determination apparatus 100 (e.g., a controller) according to the present invention may include a processor 110, a memory 140, and a plurality of units executed by the processor 110. The plurality of units may include: an image acquisition unit 120, an output unit 130, an image conversion unit 150, an image analysis unit 160, a parking line recognition unit 170, a parking area analysis unit 180, and a parking position setting unit 190.

The image acquisition unit 120, executed by the processor, may be connected to an imaging device disposed in the vehicle to collect an image captured through the imaging device. Furthermore, the image acquisition unit 120 may acquire images capturing a front, a rear, a left side, and a right side of the vehicle. FIG. 2 illustrates that the imaging device is disposed separately from the parking area determination apparatus 100, but the imaging device 1 may be implemented to be included in the parking area determination apparatus.

The output unit 130, executed by the processor, may be configured to output an operation state, result data, and the like of the parking area determination apparatus 100. The output unit 130 may be connected to a display unit disposed in a vehicle such as a monitor and a navigation and may display an operation and result screen through the monitor, the navigation, and the like.

The memory 140 may store a setting value and input data for an operation of the parking area determination apparatus 100. The memory 140 may store operation data, result data, and the like of the parking area determination apparatus 100.

The image conversion unit 150, executed by the processor may convert a view of the image acquired through the image acquisition unit 120. For example, when captured images for the front, rear, left side, and right side of the vehicle are input from the image acquisition unit 120 to the image conversion unit 150, the image conversion unit 150 may convert the view of each of the captured images to a top-view and may synthesize the converted images.

In the present invention, the image conversion unit 150 is implemented to be included in the parking area determination apparatus 100. However, when a vehicle includes an around view monitoring (AVM) system, the parking area determination apparatus 100 may receive and use an AVM image generated by the AVM system, thereby eliminating the need for the image conversion unit 150 in the parking area determination apparatus 100.

The image analysis unit 160, executed by the processor, may analyze a surrounding image of the vehicle converted by the image conversion unit 150. Furthermore, an analysis result of the surrounding image by the image analysis unit 160 may be used to recognize a parking line and a parking area. Thus, the image analysis unit 160 may analyze a color, contrast, and the like of the surrounding image to recognize the parking line and the parking area.

The parking line recognition unit 170, executed by the processor, may recognize the parking line in the surrounding image based on an analysis result of the surrounding image of the image analysis unit 160. The parking line recognition unit 170 may recognize the parking line using a color difference, a contrast difference, and the like of the surrounding image. Alternatively, the parking line recognition unit 170 may apply a well-known technology to recognize the parking line. Therefore, the detailed description of the parking line recognition unit 170 will be omitted.

The parking area analysis unit 180, executed by the processor, may sense a plurality of parking areas based on the parking line recognized by the parking line recognition unit 170. Furthermore, the parking area analysis unit 180 may analyze the sensed parking areas divided into predetermined intervals. Furthermore, the parking area analysis unit 180 may analyze each section in which each sensed parking area is divided, but the inventive concept is not limited thereto.

Specifically, the parking area analysis unit 180 may calculate a histogram variance for each analysis section in each of the sensed parking areas and may analyze change in the histogram variance for each analysis section. Furthermore, the parking area analysis unit 180 may determine that an empty space, in which a histogram is narrowly distributed, has a small variance and that an occupied space, in which a histogram is widely distributed, has a large variance.

Moreover, when the histogram variance for each analysis section in each of the sensed parking areas is less than a threshold value, the parking area analysis unit 180 may set the histogram variance for the corresponding analysis section as a reference value. Additionally, the parking area analysis unit 180 may use a comparison value for determining an occupied state of the parking area. For example, when vehicles are parked in the parking areas, and entrances of the parking areas are mostly empty, the histogram variance of the empty space in the entrance of the parking area may be set as the reference value. Furthermore, the histogram variance of the parking area set as a parkable area may be set as the reference value.

The parking position setting unit 190, executed by the processor, may determine an occupied state of the sensed parking areas according to the analysis result for the sensed parking areas to recognize an empty parking area and may set the recognized empty parking area as the parkable area.

The parking position setting unit 190 may compare analysis sections for parking areas to determine an occupied state of a corresponding parking area. Additionally, the parking position setting unit 190 may compare analysis sections corresponding to adjacent parking sections to determine the occupied state of a corresponding parking area.

As one example, the parking position setting unit 190 may compare histogram variances for analysis sections of a corresponding parking area on the basis of the reference value set by the parking area analysis unit 180 and may determine a parking area having low change in a histogram variance for the analysis sections as an empty parking area. As another example, the parking position setting unit 190 may compare histogram variances for analysis sections of corresponding positions in one parking area and another parking area adjacent thereto to determine an empty parking area.

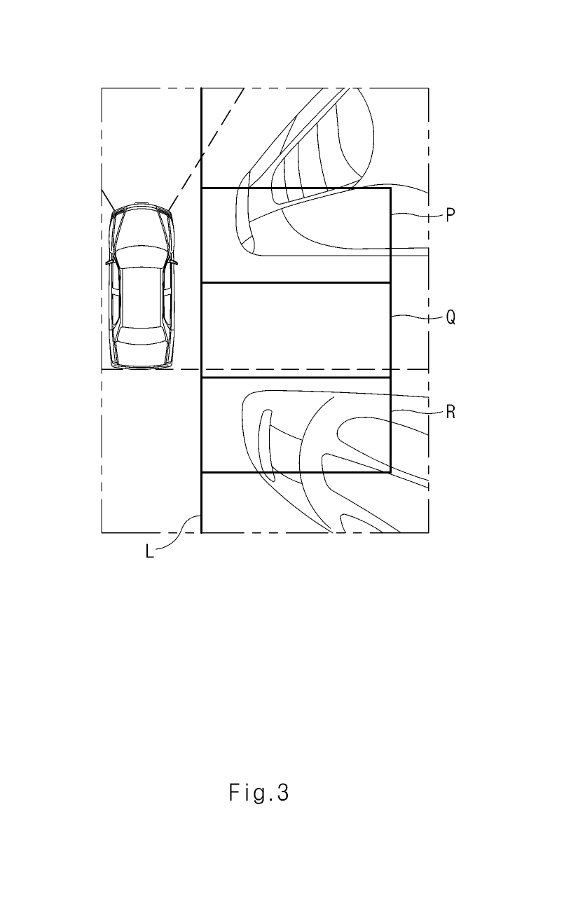

FIG. 3 is an exemplary view illustrating a parking area sensing operation of a parking area determination apparatus according to an exemplary embodiment of the present invention.

FIG. 3 illustrates a parking line and a parking area in an AVM. The parking area determination apparatus, executed by the processor, may analyze the AVM image to recognize a parking line L and may recognize parking areas through the recognized parking line. Furthermore, when the parking line is partially recognized, the parking area determination apparatus may predict a position and shape of the remaining parking area and sense the parking area through a prediction result. FIG. 3 illustrates three parking areas P, O, and R sensed through the recognized parking line L.

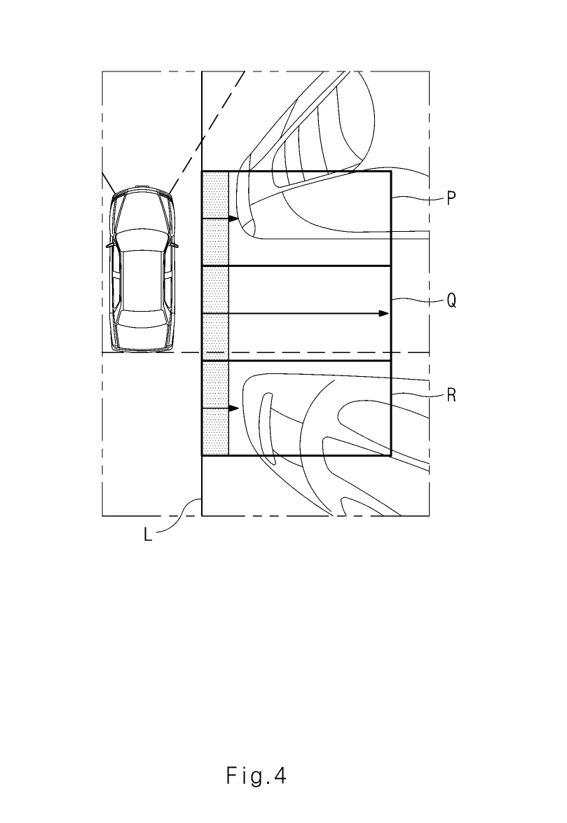

FIG. 4 is an exemplary view illustrating a reference value setting operation for a parking area in a parking area determination apparatus according to an exemplary embodiment of the present invention.

FIG. 4 illustrates an example of setting reference values for the three parking areas P, Q, and R sensed in FIG. 3. In other words, the entrances of the three parking areas P, Q, and R may be set as an empty space. Therefore, the parking area determination apparatus, executed by the processor, may set histogram variances of analysis sections as reference values when the histogram variances for the entrances of the three parking areas P, Q, and R are less than a threshold value V_{TH}.

Moreover, the parking area determination apparatus may divide, at predetermined intervals, each parking area in a parking direction from the entrance of each parking area and calculate histogram variances for analysis sections.

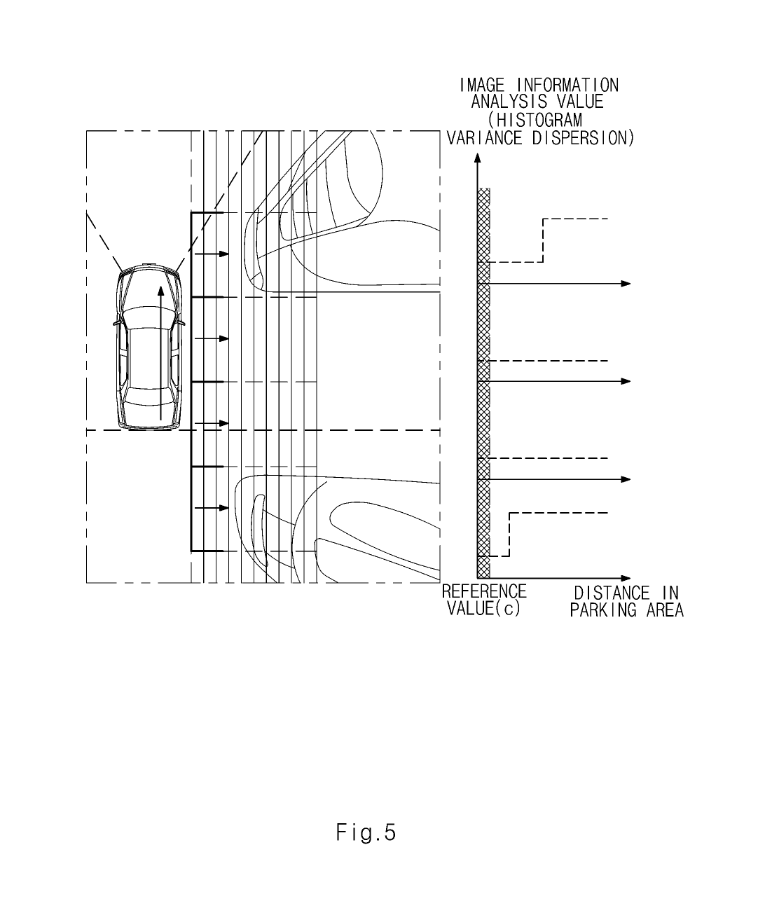

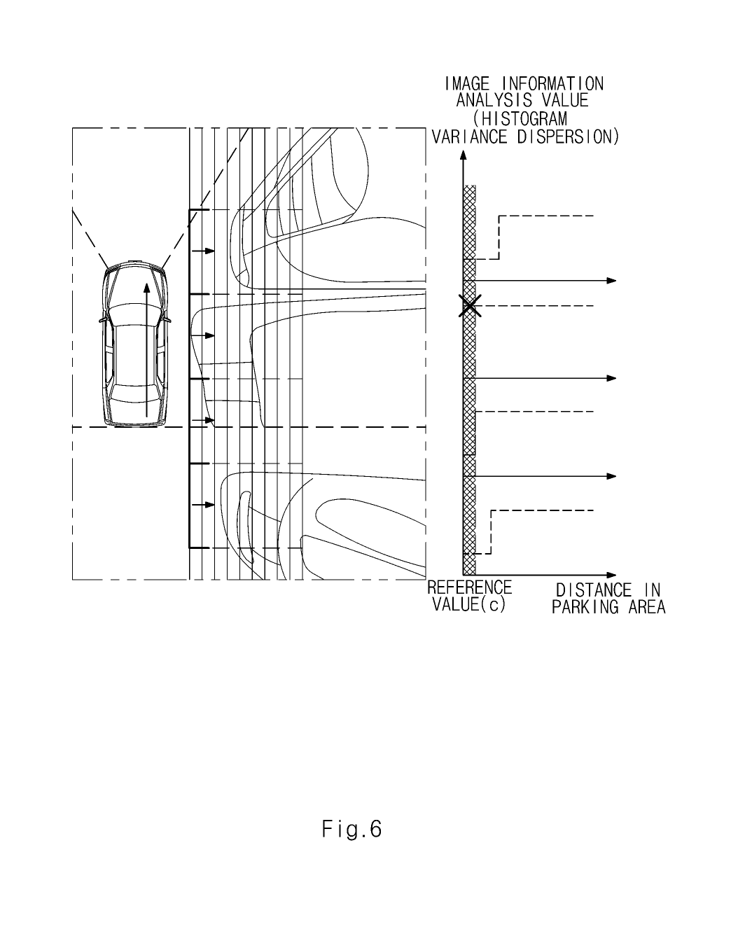

FIGS. 5 and 6 are exemplary views illustrating parking area analysis operations of the parking area determination apparatus according to the present invention.

FIG. 5 illustrates an example of analyzing a parking area with respect to a right-side area of a vehicle to be parked in an AVM image. The parking area determination apparatus, executed by the processor, may divide each parking area into a plurality of analysis sections spaced at predetermined intervals from an entrance thereof and may calculate histogram variances for the analysis sections.

FIG. 5 shows a plurality of parking areas wherein a first analysis section to a fourth analysis section may be empty spaces having low histogram and the remaining analysis sections may be occupied with a vehicle, thus including high histogram variances. Moreover, FIG. 5 illustrates in two middle parking areas among the four parking areas, wherein all of the analysis sections are empty spaces having low histogram variances. Furthermore, FIG. 5 illustrates that in the lowermost parking area among the four parking areas, a first analysis section to a third analysis section are empty spaces having low histogram variances and the remaining analysis sections from a fourth analysis section are occupied with a vehicle, thus including high histogram variances.

The parking area determination apparatus, executed by the processor, may determine an occupied state of a corresponding parking area by comparing the histogram variances of the remaining analysis sections using the histogram variance of the first analysis section in each parking area as a reference value C.

FIG. 6 illustrates an uppermost parking area among four parking areas, wherein a first analysis section to a third analysis section may be empty spaces having low histogram variances and the remaining analysis sections from a fourth analysis section are occupied with a vehicle, thus including high histogram variances. Furthermore, FIG. 6 illustrates a second upper parking area among the four parking areas, wherein a vehicle occupies the parking area from the first analysis section having low histogram variances.

Moreover FIG. 6 illustrates a second lower parking area among the four parking areas, wherein a first analysis section may be an empty space having a low histogram variance and the remaining analysis sections from a second analysis section may be occupied with a vehicle, thus including high histogram variances. Additionally, FIG. 6 illustrates a lowermost parking area among the four parking areas, wherein a first analysis section and a second analysis section may be empty space having low histogram variance and the remaining analysis sections from a third analysis section may be occupied with a vehicle, thus including high histogram variances.

The parking area determination apparatus, executed by the processor, may determine an occupied state of a corresponding parking area by comparing the histogram variances of the other analysis section using the histogram variance of the first analysis section in each parking area as a reference value C, except the first analysis section of the second upper parking area since it is not an empty space.

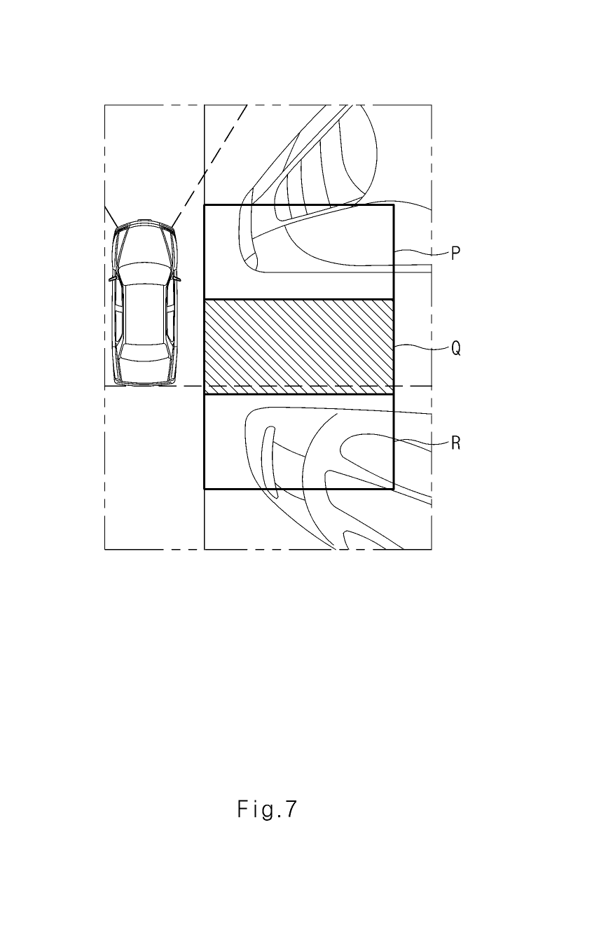

FIG. 7 is an exemplary view illustrating a parkable area setting operation of a parking area determination apparatus, executed by a processor, according to the present invention.

Referring to FIG. 7, the parking area determination apparatus may determine an occupied state of each parking area by comparing the histogram variances of the parking areas through the methods illustrated in FIGS. 5 and 6. Through the above-described methods, the parking area determination apparatus may determine that the parking areas P and R are occupied parking areas and the parking area Q is an empty parking area and may therefore set the empty parking area Q as a parkable area.

Thus, when the parkable area is not visible to a user due to a blind spot, the user may receive a parking supporting service with respect to the parking area set as the parkable area from a parking supporting system.

An operation flow of the parking area determination apparatus having the above-described configuration according to the present invention will be described in detail.

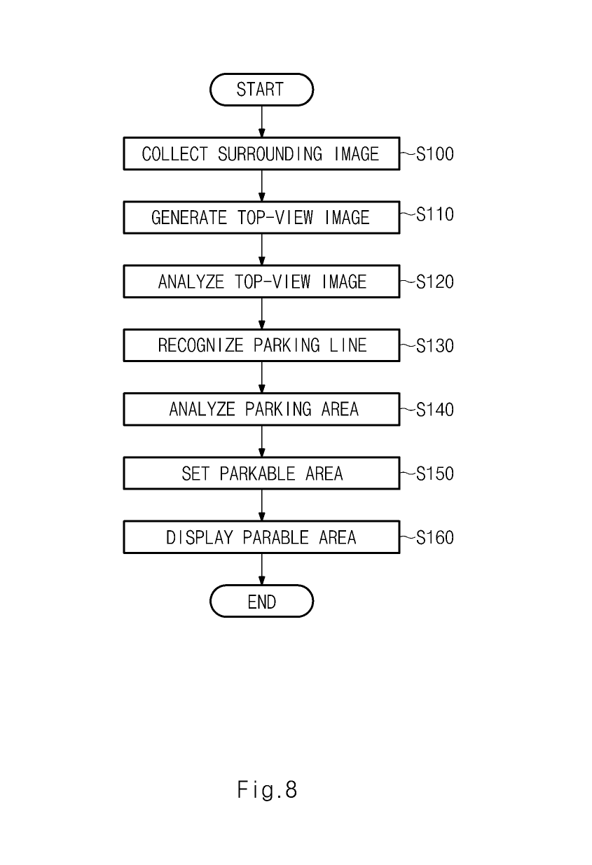

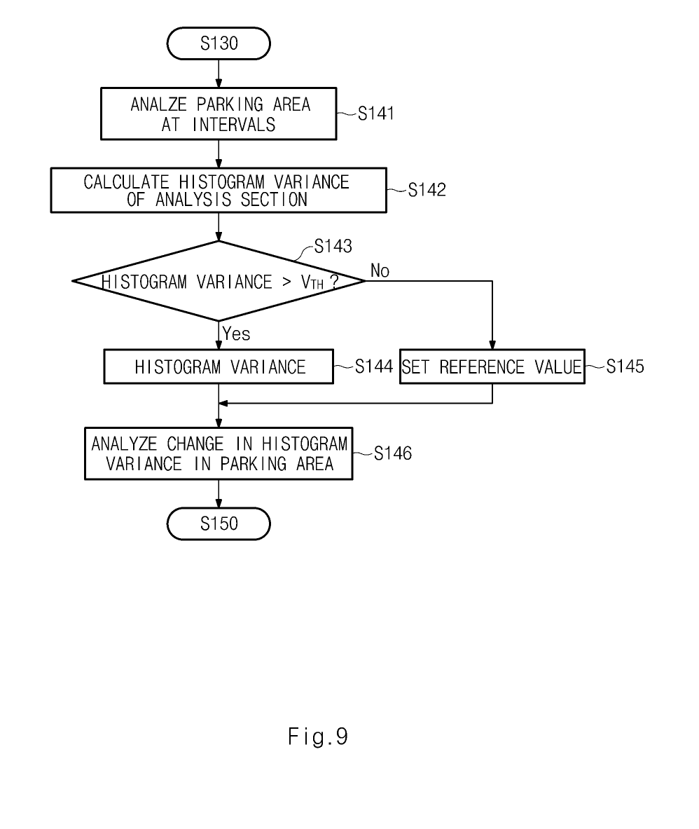

FIGS. 8 and 9 are exemplary flowcharts illustrating a method of a parking area determination method according to an exemplary embodiment of the present invention.

Referring to FIG. 8, the parking area determination apparatus, executed by a processor, may collect a surrounding image of a vehicle through an imaging device of the vehicle (S 100), may perform view conversion on the collected surrounding image, and may generate a top-view image (S110). When an AVM system is disposed in the vehicle, the parking area determination apparatus may receive and use an AVM image from the AVM system wherein the processes S100 and S110 may be omitted.

The parking area determination apparatus, executed by the processor, may analyze the top-view generated image (S120), recognize a parking line (S130), and sense a plurality of parking areas from the recognized parking line recognized.

Furthermore, the parking area determination apparatus may analyze the sensed parking areas (S140) and may determine an occupied state of the parking areas. Thus, the parking area determination apparatus may set an empty parking area as a parkable area from the analysis result (S150) and may display the parkable area through a monitor or navigation screen of the vehicle (S160).

FIG. 9 illustrates a detailed method with respect to the process of S140 in FIG. 8.

Referring to FIG. 9, the parking area determination apparatus, executed by the processor, may divide at predetermined intervals, each of the parking areas sensed from the parking line into sections and may analyze the sections of each parking area (S141).

Moreover, the parking area determination apparatus may calculate a histogram variance for each analysis section (S142). When the histogram variance of a corresponding analysis section is larger than a threshold value V_{TH} (S143), the histogram variance of the corresponding analysis section is excluded from a reference value (S144). Alternatively, the parking area determination apparatus may set the histogram variance of the corresponding analysis section as the reference value (S145). Furthermore, the highest value among histogram variances for analysis sections of each parking area, in which a vehicle is not occupied, may be set as the reference value V_{TH}, but the present invention is not limited thereto.

Thus, the parking area determination apparatus, executed by the processor, may analyze a change in the histogram variances of the parking area (S146) and determine an occupied state of each parking area based on an analysis result in the process of S146.

The parking area determination apparatus and method according to the present invention have been described with reference to the illustrated drawings, the present invention is not limited by the embodiment and drawings disclosed in this disclosure and may be applied within the coverage of the technology spirit.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for determining a parking area, the apparatus comprising:
a processor configured to:
analyze a surrounding image of a vehicle;
recognize a parking line in the surrounding image based on the analysis of the surrounding image;
sense a plurality of parking areas based on the recognized parking line;
analyze the plurality of sensed parking areas divided into a plurality of predetermined intervals;
determine an occupied state of the plurality of sensed parking areas based on analyzing each sensed parking area; and
set an empty parking area as a parkable area.

2. The apparatus of claim 1, wherein the processor is further configured to:
calculate a plurality of histogram variances for the plurality of predetermined intervals in each sensed parking area; and
analyze a change in the plurality of histogram variances for the plurality of predetermined intervals in each sensed parking area.

3. The apparatus of claim 2, wherein the processor is further configured to set a histogram variance of a corresponding predetermined interval as a reference value when a histogram variance for each predetermined interval in each sensed parking area is less than a threshold value.

4. The apparatus of claim 3, wherein the processor is further configured to determine a parking area, in which the change in the histogram variance for each predetermined interval in each sensed parking area is low, as the empty parking area based on the set reference value.

5. The apparatus of claim 2, wherein the processor is further configured to determine the empty parking area by comparing the change in histogram variances of the plurality of predetermined intervals in adjacent parking areas, in which the plurality of predetermined intervals correspond to each other.

6. A method for determining a parking area, the method comprising:
analyzing, by a processor, a surrounding image of a vehicle;
recognizing, by the processor, a parking line in the surrounding image based on the analysis of the surrounding image;
sensing, by the processor, a plurality of parking areas based on the recognized parking line;
analyzing, by the processor, the plurality of sensed parking areas divided into predetermined intervals;
determining, by the processor, an occupied state of the sensed parking areas based on analysis of the plurality of sensed parking areas; and
setting, by the processor, an empty parking area as a parkable area.

7. The method of claim 6, wherein analyzing the plurality of sensed parking areas further includes:
calculating, by the processor, a plurality of histogram variances for a plurality of analysis sections divided into the predetermined intervals in each sensed parking area; and
analyzing, by the processor, a change in the histogram variances for the plurality of analysis sections.

8. The method of claim 7, wherein analyzing the plurality of sensed parking areas further includes setting, by the processor, a histogram variance of a corresponding analysis section as a reference value when the plurality of histogram variances for the plurality of analysis sections in each sensed parking area is less than a threshold value.

9. The method of claim 8, wherein setting a parkable area further includes determining, by the processor, a parking area, in which the change in plurality of the histogram variances for the plurality of analysis sections in each sensed parking area is low, as an empty parking area based on the set reference value.

10. The method of claim 7, wherein setting a parkable area further includes determining, by the processor, the empty parking area by comparing the change in the plurality of histogram variances for the plurality of analysis sections for adjacent parking areas, in which the plurality of analysis sections correspond to each other.

11. A non-transitory computer readable medium containing program instructions executed by a processor, the computer readable medium comprising:
program instructions that analyze a surrounding image of a vehicle;
program instructions that recognize a parking line in the surrounding image based on the analysis of the surround image;
program instructions that sense a plurality of parking areas based on the recognized parking line; and
program instructions that analyze the plurality of sensed parking areas divided into a plurality of predetermined intervals; and
program instructions that determine an occupied state of the plurality of sensed parking areas based on analyzing each sensed parking area; and
program instructions that set an empty parking area as a parkable area.

12. The computer readable medium of claim 11, further comprising:
program instructions that calculate a plurality of histogram variances for the plurality of predetermined intervals in each sensed parking area; and
program instructions that analyze a change in the plurality of histogram variances for the plurality of predetermined intervals in each sensed parking area.

13. The computer readable medium of claim 12, further comprising program instructions that set a histogram variance of a corresponding predetermined interval as a reference value when a histogram variance for each predetermined interval in each sensed parking area is less than a threshold value.

14. The computer readable medium of claim 13, further comprising program instructions that determine a parking area, in which the change in the histogram variance for each predetermined interval in each sensed parking area is low, as the empty parking area based on the set reference value.

15. The computer readable medium of claim 12, further comprising program instructions that determine the empty parking area by comparing the change in histogram variances of the plurality of predetermined intervals in adjacent parking areas, in which the plurality of predetermined intervals correspond to each other.
